(19) United States
(12) Patent Application Publication
(10) Pub. No.: US 2017/0344306 A1
(43) Pub. Date: Nov. 30, 2017

(54) NODE MANAGEMENT FOR ATOMIC PARALLEL DATA PROCESSING

(71) Applicant: MICROSOFT TECHNOLOGY LICENSING, LLC, Redmond, WA (US)

(72) Inventors: AJESH GEORGE, BOTHELL, WA (US); DEBASHISH GHOSAL, KIRKLAND, WA (US); ARTUR ZBIGNIEW GAWRONSKI, SEATTLE, WA (US)

(21) Appl. No.: 15/166,436

(22) Filed: May 27, 2016

(51) Int. Cl. G06F 3/06

(52) U.S. Cl. CPC G06F 3/0644; G06F 3/0673; G06F 3/0604; G06F 3/0653; G06F 3/0664

(57) ABSTRACT

The technology described herein allows processing nodes in a parallel processing environment to determine whether a data partition is being atomically processed. The processing nodes can maintain the atomic processing of data by checking for challenger nodes assigned to the same partition and checking whether the node is still the leader node for a partition at a given frequency and/or at key points during the data processing flow. When a processing node detects a challenger node, the node self-terminates. When a challenger node detects no other nodes assigned to its data partition, then it designates itself or confirms itself as the leader node and begins or continues processing data within the partition. A node can detect other nodes by checking a node log that each processing node updates upon completing a survey of its present status.

### BACKGROUND

Large amounts of data can be processed in real time by breaking down the data into small partitions and processing each partition with a separate processing node. A central controller can be used to ensure that a processing node is allocated for each partition. Due to network issues and other problems within the computing environment, the controller can falsely assume that a processing node is shut down and start a fresh node for the partition. This results in duplicate nodes processing the same data causing data corruption, energy inefficiency, and an inefficient deployment of computer resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein allows processing nodes in a parallel processing environment to determine whether a data partition is being atomically processed. As used herein, atomic processing means that only a single node is processing a given data partition. When two nodes are assigned to the same data partition, then the processing is not atomic. The processing nodes can maintain the atomic processing of data by checking for challenger nodes assigned to the same partition and checking whether the node is still the leader node for a partition at a given frequency and/or at key points during the data processing flow. A node can detect other nodes by checking a node log that each processing node updates upon completing a survey of its present status.

Each processing node can be one of two different statuses: leader or challenger. Upon initialization, each node is designated as a challenger and can be registered in the node log as a challenger assigned to a specific data partition. The node can be initiated by a controller responsible for making sure that a node is assigned to process each partition. The controller can assign the node to a partition and provide instructions regarding the processing operations to be performed by the node.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure;

FIG. 2 is a diagram depicting an example computing architecture showing a node initiating with a challenger status;

FIG. 3 is a diagram depicting an example computing architecture showing a node transitioning from challenger to leader status;

FIG. 4 is a diagram depicting an example computing architecture showing both a leader node and a challenger node assigned to the same data partition;

FIG. 5 is a diagram depicting an example computing architecture showing both a leader node deactivating in response to a challenger and a challenger node transitioning to leader status;

FIGS. 6-8 are flow diagrams showing methods of managing atomic processing of a data partition, in accordance with an aspect of the technology described herein; and

FIG. 9 is a block diagram of an exemplary computing environment suitable for use in implementing aspects of the technology described herein.

### DETAILED DESCRIPTION

The various technology described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein allows processing nodes in a parallel processing environment to determine whether a data partition is being atomically processed. As used herein, atomic processing means that a single node is processing a given data partition. When two nodes are assigned to process the same data partition, then the processing is not atomic. The processing nodes can maintain the atomic processing of data by checking for challenger nodes assigned to the same partition and checking whether the node is still the leader node for a partition at a given frequency and/or at key points during the data processing flow. When a processing node detects a challenger node, the node self-terminates. When a challenger node detects no other nodes assigned to its data partition, then it designates itself the leader node and begins processing data within the partition. A node can detect other nodes by checking a node log that each processing node updates upon completing a survey of its present status.

Each processing node can have one of two different statuses: leader or challenger. Upon initialization, each node is designated as a challenger and can be registered in the node log as a challenger assigned to a specific data partition. The node log can record the status of each node within a processing system and can be edited by the processing nodes or in response to communications received from the processing nodes. A node can be initiated by a controller responsible for making sure that a node is assigned to process each partition. The controller can assign the node to a partition and provide instructions regarding the processing operations to be performed by the node.

An individual node can perform a node status survey upon the occurrence of a triggering event. The node status survey determines how many processing nodes are assigned to a particular data partition. Specifically, the node can determine whether any other nodes are assigned to the data partition the node is assigned to process. The node can also determine its status in the log and the status of any other nodes assigned to the same data partition. Depending on its status, different actions can be taken when a second node is detected. When no other nodes are detected, then the node can re-register its leader status and take the next data processing step.

The occurrence of a triggering event can be determined by a process executed by the node. In one aspect, the triggering events are defined by a series of heuristics. Each heuristic includes parameters of a node state that define the triggering criteria. When the node state matches the triggering criteria, then a node survey can be initiated. Accordingly, each node can include a monitoring function that evaluates a state of the node against triggering criteria and provides a notification when the node state matches the criteria.

In one aspect, the triggering event can be node initialization. Initialization is the process of activating the node and assigning it to a data partition. The node can be a combination of computer-executable instructions and computer resources used to execute the instructions. In one aspect, the computer resources can be a virtual machine. The initialization status survey can be a one-time check that occurs within a threshold time from the node being initialized. The state parameters could be that the node is in existence less than a threshold time and that initialization status survey has not occurred previously.

A node performing a survey is described herein as the surveying node. The survey can occur by interrogating a node log that records the status of each active processing node as either a leader or challenger along with the data partition each node is assigned to process. The result of the interrogation can be a listing of nodes associated with a data partition of interest along with the status assigned to each node.

For the initialization survey, the surveying node determines whether a second node designated as a leader is assigned to the same data partition as the surveying node. If a leader node is not detected, then the surveying node registers itself as the leader node and begins processing data within the data partition. If a leader node is detected, then the surveying node waits a threshold period of time, for example, 30 seconds, a minute, two minutes, five minutes, or ten minutes, and then performs a second node survey to determine if a leader node is still associated with the data partition. If no other node is associated with the data partition, the surveying node registers itself as a leader node for the data partition and begins processing data. The threshold period of time can be the same as or related to the periodic period of time associated with the periodic triggering event. In one aspect, the threshold period of time is a few seconds longer than the periodic threshold period of time. In this way, the leader node should terminate before the second survey occurs as part of the initialization check, as explained in more detail below.

The periodic triggering event occurs in regular intervals, such as every two minutes, three minutes, five minutes, or ten minutes. The triggering criteria can be the time elapsed since the last status survey performed for the node. The periodic status survey determines whether a challenger node is associated with the same data partition as the surveying node. If a challenger node is not detected, then the surveying node can re-register within the node log as the leader node for the data partition and continue processing data. If a challenger node is detected, then the surveying node removes itself from the node log and terminates.

A data processing triggering event detects important steps of the data processing method. Before undertaking a particular data processing step, a node can perform a node survey to determine whether the node should continue as leader and take the next processing steps. Exemplary processing steps that could trigger a note status survey include: completion of data aggregation from the data partition, completion of processing of aggregated data, and writing of processing results. Data processing methods can vary and triggering event criteria can be adjusted to match a given data processing flow.

As used herein, a data processing node is a processing element that performs one or more computing tasks. A node can receive or retrieve data, perform one or more data operations, and generate an output. Intermediary steps are possible. Each instance of a node runs the same code and performs the same one or more functions, though possibly for different data partitions.

A data partition, as used herein, is a logical partition of a database or some other collection of data into distinct independent parts. The logical partition can be based on a characteristic of the data, such as a time stamp. For example, a partition could be based on a range of data. A hash, a list of values, or some other method could be used to partition data.

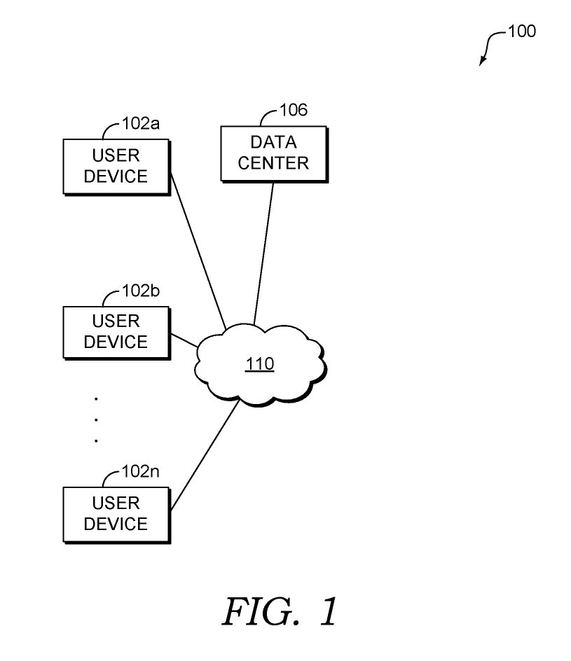

Having briefly described an overview of aspects of the technology described herein, an exemplary operating environment in which aspects of the technology described herein may be implemented is described below in order to provide a general context for various aspects. Referring to the figures in general and initially to FIG. 1 in particular, an exemplary operating environment for implementing technology described herein is shown and designated generally as exemplary operating environment 100.

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

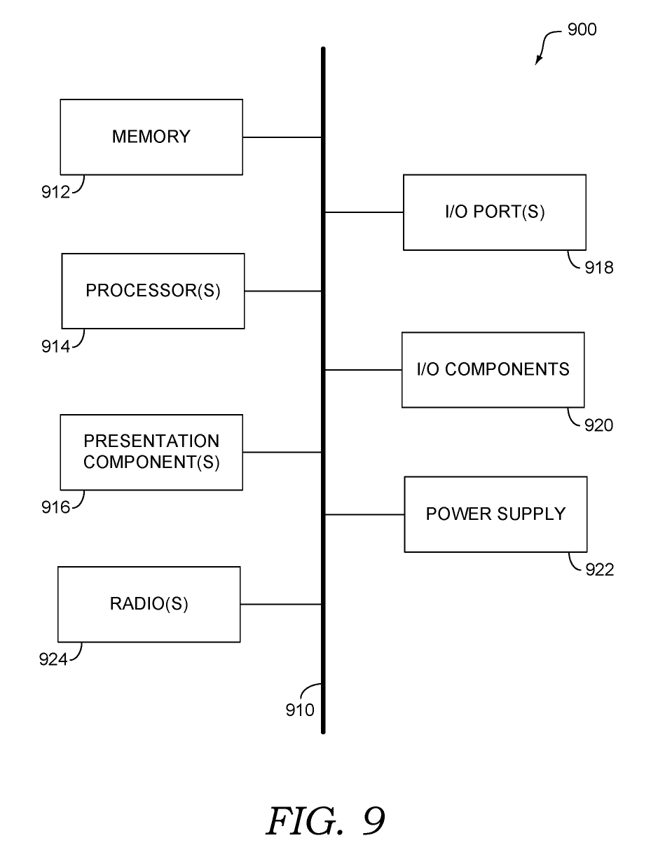

Among other components not shown, example operating environment 100 includes a number of user devices, such as user devices 102a and 102b through 102n; data center 106; and network 110. It should be understood that environment 100 shown in FIG. 1 is an example of one suitable operating environment. Each of the components shown in FIG. 1 may be implemented via any type of computing device, such as computing device 900 described in connection to FIG. 9, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

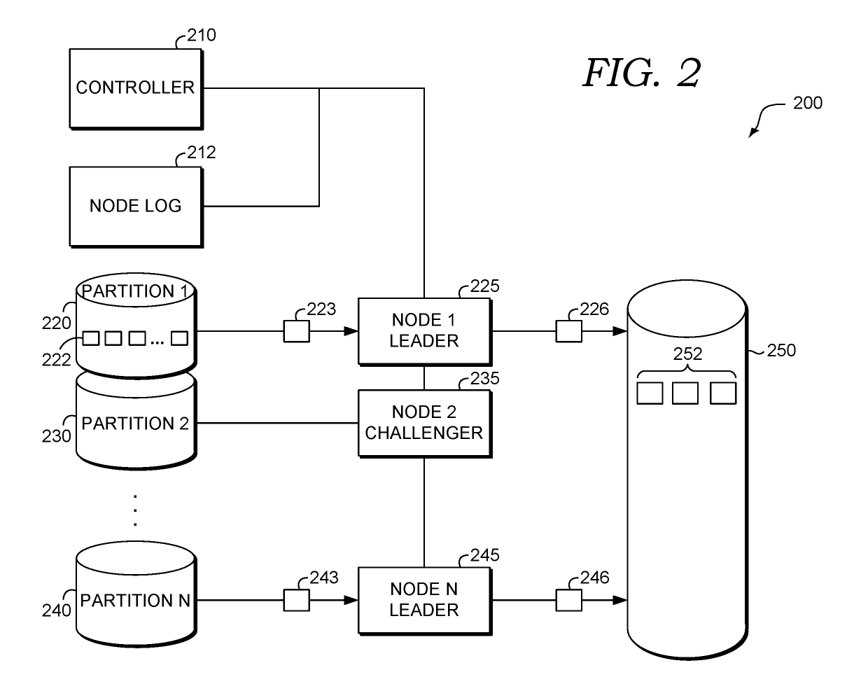

User devices 102a and 102b through 102n can be client devices on the client-side of operating environment 100, while data center 106 can be on the server-side of operating environment 100. The output generated by processing nodes could be presented to the user devices. Data center 106 can comprise a plurality of servers and server-side software designed to work in conjunction with client-side software on user devices 102a and 102b through 102n. The parallel processing described herein can occur on the data center 106. For example, the entirety of the computing environment 200 of FIG. 2 could be in the data center 106. This division of operating environment 100 is provided to illustrate one example of a suitable environment, and there is no requirement for each implementation that any combination of data center 106 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 9 herein. By way of example and not limitation, a user device may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

Referring now to FIG. 2, with FIG. 1, a block diagram is provided showing aspects of an example computing system architecture suitable for implementing an aspect of the technology and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some aspects functionality of these components can be shared or distributed across other components.

Example system 200 includes a node controller 210, a node log 212, a first data partition 220, a second data partition 230, and an Nth data partition 240. The node controller 210 starts and stops processing instances and assigns processing instances to various data partitions. Each data partition comprises computer-readable media storing computer data, such as data records 222 shown in the first partition 220. The partitions can be logical partitions of a database or some other collection of data into distinct independent parts. The logical partition can be based on a characteristic of the data, such as a time stamp. For example, a partition of the data records 222 could be based on a range of data. A hash, a list of values, or some other method could be used to partition data. Each data record 222 could represent a row in a database, a part of a data stream, or some other subset of data.

The node log 212 can comprise a computer-readable media with information about each active node. The node log 212 can be accessed by the nodes in the system 200 such as a first node 225, a second node 235, or an Nth node 245. The data processing nodes are processing elements that perform one or more computing tasks on the data. A node can receive or retrieve data, perform one or more data operations, and generate an output. Intermediary steps are possible. Each instance of a node runs the same code and performs the same one or more functions, though possibly for different data partitions. A parallel processing system can employ different processing nodes for different purposes. The nodes 225, 235, and 245 could perform the same or different tasks.

The first processing node 225 and the Nth processing node 245 have a leader status and are processing data. The second processing node 235 is a challenger status and is not processing data. The first processing node 225 retrieves a data record 223 from the first partition 220. In one aspect, a plurality of data records could be aggregated for processing. In another aspect, individual data records are processed discreetly. Depending on the function performed by the first node 225, individual data entries from the record 223 could be used in the process without using all data in the record. The first node 225 performs its function to generate an output record 226. The output record 226 is stored in result data store 250. The result set 252 could go on to subsequent processing steps (not shown), be presented to the user, or be stored for later use. The Nth node 245 retrieves the data record 243 from the Nth data partition 240 and processes it to generate the output record 246. The output record 246 is stored in result data store 250.

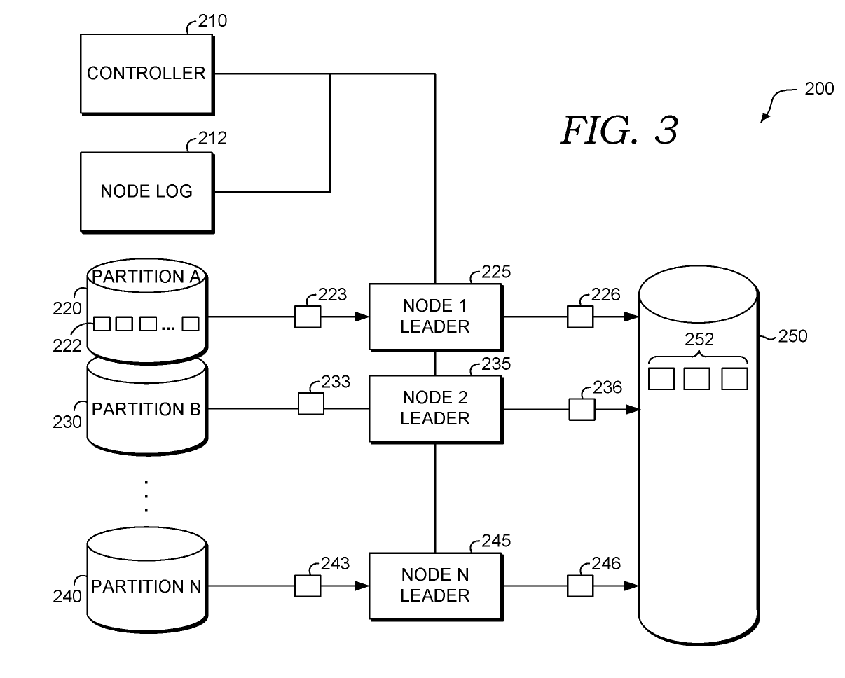

Turning now to FIG. 3, a change in node status is illustrated according to an aspect of the technology described herein. The second processing node 235 has transitioned from the challenger state shown in FIG. 2 to a leader state shown in FIG. 3. The second node 235 is now processing data. The second node 235 retrieves a data record 233 from the second data partition 230 and processes it to generate an output record 236. The output record 236 is stored in result data store 250.

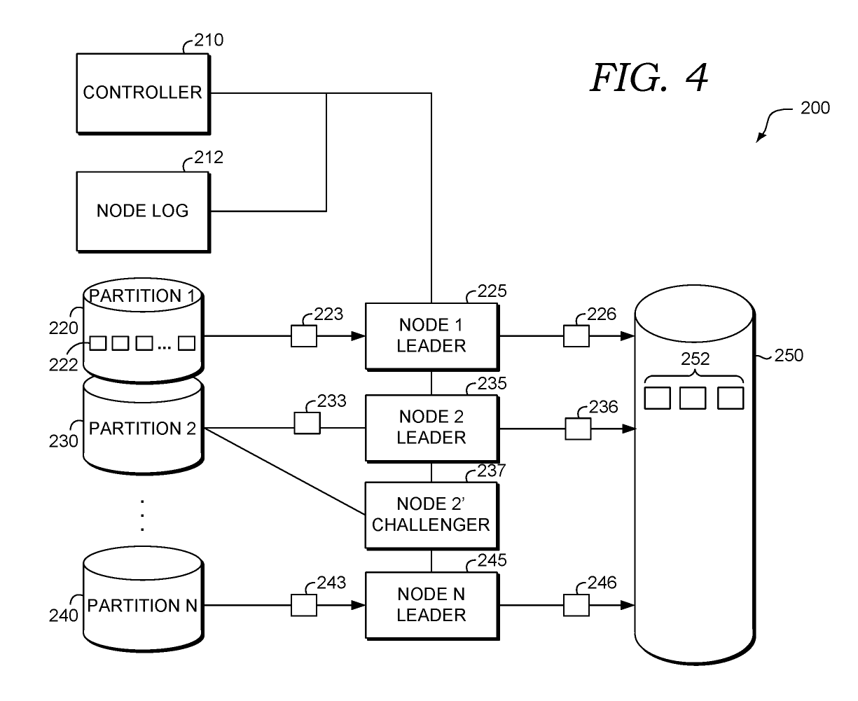

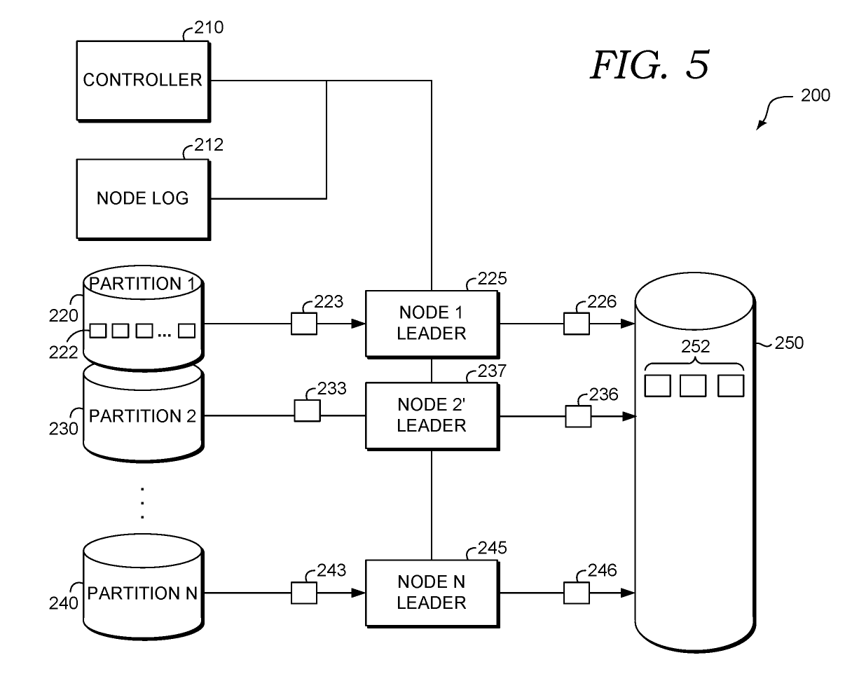

Turning now to FIG. 4, the multiple assignments of nodes to a data partition is illustrated. As can be seen, the second node 235 is in leader status and continues to process data. The second prime node 237 is in challenger status and is not processing data. Upon initialization the second prime node 237 can determine that the second node 235 is in leader status by checking the node log 212. Upon making this determination, the second prime node 237 can wait a threshold period. The second node 235 will eventually perform a node survey and discover the second prime node challenger 237. The node survey can be triggered by the passing of time or the completion of a processing step. Upon detecting the challenger node, the second node 235 will remove itself from the node log and terminate. When the second prime node 237 performs a second initialization survey upon the passing of the threshold period, the second node 235 will be terminated and the second prime node 237 can register as the leader and start processing data, as is shown in FIG. 5.

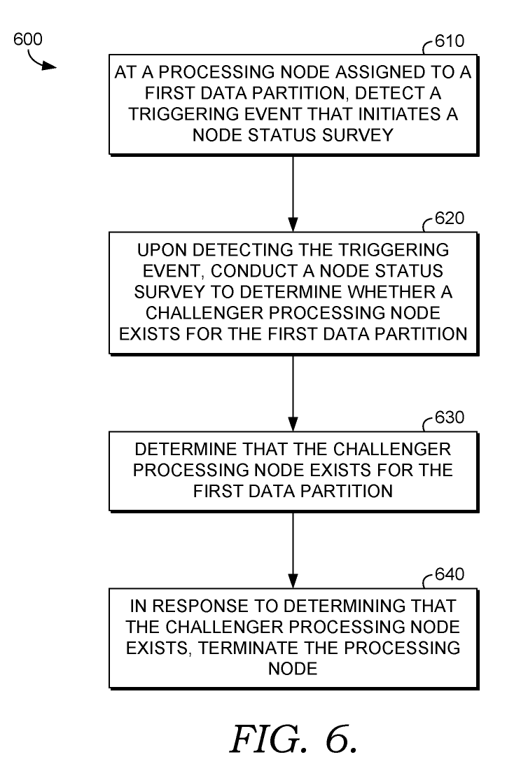

Turning now to FIG. 6, a method 600 of managing atomic processing of a data partition is shown, according to aspects of the technology described herein.

At step 610, at a processing node assigned to a first data partition, a triggering event that initiates a node status survey is detected. The occurrence of a triggering event can be determined by a process executed by the node. In one aspect, the triggering events are defined by a series of heuristics. Each heuristic includes parameters of a node state that define the triggering criteria. When the node state matches the triggering criteria, then a node survey can be initiated. Accordingly, each node can include a monitoring function that evaluates a state of the node against triggering criteria and provides a notification when the node state matches the criteria.

In one aspect, the triggering event can be node initialization. The initialization status survey can be a one-time check that occurs within a threshold time from the node being initialized. The state parameters could be that the node is in existence less than a threshold time and that initialization status survey has not occurred previously. In another aspect, the trigger criteria is the passing of time. In another aspect, the trigger criteria is the completion of a processing step.

At step 620, upon detecting the triggering event, a node status survey to determine whether a challenger processing node exists for the first data partition is conducted. The node status survey can comprise interrogating a record that tracks a status of processing nodes and assignments, as described previously. For the initialization survey, the surveying node determines whether a second node designated as a leader is assigned to the same data partition as the surveying node. If a leader node is not detected, then the surveying node registers itself as the leader node and begins processing data within the data partition. If a leader node is detected, then the surveying node waits a threshold period of time, for example, 30 seconds, a minute, two minutes, five minutes, or ten minutes, and then performs a second node survey to determine if a leader node is still associated with the data partition. If no other node is associated with the data partition, the surveying node registers itself as a leader node for the data partition and begins processing data. The threshold period of time can be the same as or related to the periodic period of time associated with the periodic triggering event. In one aspect, the threshold period of time is a few seconds longer than the periodic threshold period of time. In this way, the leader node should terminate before the second survey occurs as part of the initialization check, as explained in more detail below.

The periodic triggering event occurs in regular intervals, such as every two minutes, three minutes, five minutes, or ten minutes. The triggering criteria can be the time elapsed since the last status survey performed for the node. The periodic status survey determines whether a challenger node is associated with the same data partition as the surveying node. If a challenger node is not detected, then the surveying node can reregister within the node log as the leader node for the data partition and continue processing data. If a challenger node is detected, then the surveying node removes itself from the node log and terminates.

A data processing triggering event detects important steps of the data processing method. Before undertaking a particular data processing step, a node can perform a node survey to determine whether the node should continue as leader and take the next processing steps. Exemplary processing steps that could trigger a note status survey include: completion of data aggregation from the data partition, completion of processing of aggregated data, and writing of processing results. Data processing methods can vary and triggering event criteria can be adjusted to match a given data processing flow.

At step 630, the challenger processing node is determined to exist for the first data partition. At step 640, in response to determining that the challenger processing node exists, the processing node is terminated. The processing node could be deregistered from a record, such as the node log.

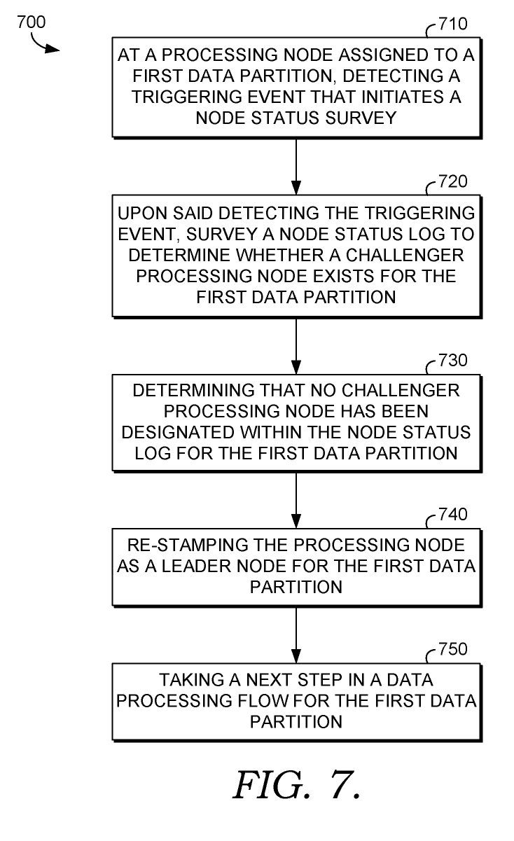

Turning now to FIG. 7, a method 700 of managing atomic processing of a data partition is shown, according to aspects of the technology described herein.

At step 710, at a processing node assigned to a first data partition, the method includes detecting a triggering event that initiates a node status survey. The occurrence of a triggering event can be determined by a process executed by the node. In one aspect, the triggering events are defined by a series of heuristics. Each heuristic includes parameters of a node state that define the triggering criteria. When the node state matches the triggering criteria, then a node survey can be initiated. Accordingly, each node can include a monitoring function that evaluates a state of the node against triggering criteria and provides a notification when the node state matches the criteria.

In one aspect, the triggering event can be node initialization. The initialization status survey can be a one-time check that occurs within a threshold time from the node being initialized. The state parameters could be that the node is in existence less than a threshold time and that initialization status survey has not occurred previously. In another aspect, the trigger criteria is the passing of time. In another aspect, the trigger criteria is the completion of a processing step.

At step 720, upon said detecting the triggering event, a node status log is surveyed to determine whether a challenger processing node exists for the first data partition.

At step 730, the method determines that no challenger processing node has been designated within the node status log for the first data partition. At step 740, the processing node is re-stamped as a leader node for the first data partition within the node status log. At step 750, a next step in a data processing flow is taken for the first data partition.

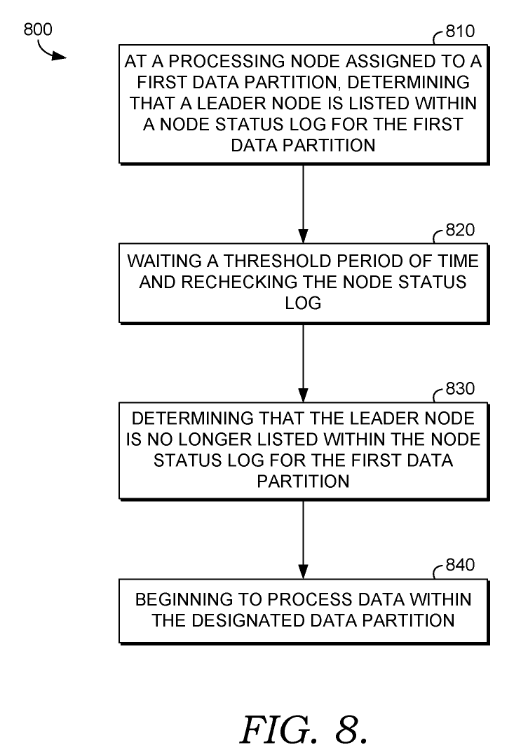

Turning now to FIG. 8, a method 800 of managing atomic processing of a data partition is shown, according to aspects of the technology described herein.

At step 810, at a processing node assigned to a first data partition, a determination is made by a surveying node classified as a challenger that a leader node is listed within a node status log for the first data partition. The surveying node is also associated with the first data partition.

At step 820, a threshold period of time is allowed to pass and then the node status log is resurveyed. If a leader node is detected, then the surveying node waits a threshold period of time, for example, 30 seconds, a minute, two minutes, five minutes, or ten minutes, and then performs a second node survey to determine if a leader node is still associated with the data partition. If no other node is associated with the data partition, the surveying node registers itself as a leader node for the data partition and begins processing data. The threshold period of time can be the same as or related to the periodic period of time associated with the periodic triggering event. In one aspect, the threshold period of time is a few seconds longer than the periodic threshold period of time. In this way, the leader node should terminate before the second survey occurs.

Through the survey, at step 830, a determination is made that the leader node is no longer listed within the node status log for the first data partition. At step 840, the surveying node begins to process data within the designated data partition. The surveying node can register as the leader within the node status log.

### Exemplary Operating Environment

Referring to the drawings in general, and initially to FIG. 9 in particular, an exemplary operating environment for implementing aspects of the technology described herein is shown and designated generally as computing device 900. Computing device 900 is but one example of a suitable computing environment and is not intended to suggest any limitation as to the scope of use of the technology described herein. Neither should the computing device 900 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, and an illustrative power supply 922. Bus 910 represents what may be one or more busses (such as an address bus, data bus, or a combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 9 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or nonvolatile memory. The memory 912 may be removable, non-removable, or a combination thereof. Exemplary memory includes solid-state memory, hard drives, optical-disc drives, etc. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, vibrating component, etc. I/O ports 918 allow computing device 900 to be logically coupled to other devices, including I/O components 920, some of which may be built in.

Illustrative 110 components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 900. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include a radio 924. The radio 924 transmits and receives radio communications. The computing device may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

### EMBODIMENTS

### Embodiment 1

A computing system comprising: a processor; and computer storage memory having computer-executable instructions stored thereon which, when executed by the processor, configure the computing system to: at a processing node assigned to a first data partition, detect a triggering event that initiates a node status survey; upon detecting the triggering event, conduct a node status survey to determine whether a challenger processing node exists for the first data partition; determine that the challenger processing node exists for the first data partition; and in response to determining that the challenger processing node exists, terminate the processing node.

### Embodiment 2

The system of embodiment 1, wherein the triggering event is the passage of a designated amount of time since a previous status survey was performed by the processing node.

### Embodiment 3

The system of any one of the above embodiments, wherein the method further comprises removing the association between the processing node and the first data partition.

### Embodiment 4

The system of any one of the above embodiments, wherein the triggering event is completion of a data aggregation process from the first partition in preparation for batch processing.

### Embodiment 5

The system of any one of the above embodiments, wherein the triggering event is completion of a data processing step prior to writing a result of the data processing to storage.

### Embodiment 6

The system of any one of the above embodiments, wherein the triggering event is completion of writing a result of the data processing to data to storage.

### Embodiment 7

The system of any one of the above embodiments, wherein the processing node is a virtual machine.

### Embodiment 8

A method of managing atomic processing of a data partition, the method comprising: at a processing node assigned to a first data partition, detecting a triggering event that initiates a node status survey; upon said detecting the triggering event, surveying a node status log to determine whether a challenger processing node exists for the first data partition; determining that no challenger processing node has been designated within the node status log for the first data partition; re-stamping the processing node as a leader node for the first data partition; and taking a next step in a data processing flow for the first data partition.

### Embodiment 9

The method of as in embodiment 8, wherein the triggering event is the passage of a designated amount of time since a status survey was last performed by the processing node.

### Embodiment 10

The method as in embodiment 9, wherein the designated amount of time is between ten seconds and five minutes.

### Embodiment 11

The method as in one of embodiments 8-10, wherein the triggering event is completion of a data aggregation process from the first partition in preparation for batch processing.

### Embodiment 12

The method as in one of embodiments 8-11, wherein the triggering event is completion of a data processing step prior to writing a result of the data processing to storage.

### Embodiment 13

The method as in one of embodiments 8-12, wherein the triggering event is completion of writing a result of the data processing to data to storage.

### Embodiment 14

The method as in one of embodiments 8-13, wherein the processing node is within a parallel processing computer environment.

### Embodiment 15

The method as in one of embodiments 8-14, wherein the method further comprises: determining that a leader node is listed within the node status log for the designated data partition; waiting a threshold period of time and rechecking the node status log; determining that the leader node is no longer listed within the node status log for the designated data partition; and beginning to process data within the designated data partition.

### Embodiment 16

A method managing atomic processing of a data partition comprising: at a processing node assigned to a first data partition, surveying a node status log to determine that a leader node is listed within the node status log for the first data partition; waiting a threshold period of time and then resurveying the node status log; determining that the leader node is no longer listed within the node status log for the first data partition; and beginning to process data within the designated data partition.

### Embodiment 17

The method of embodiment 16, further comprising: at the processing node assigned to the first data partition, detecting a triggering event that initiates a node status survey; upon said detecting the triggering event, surveying a node status log to determine whether a challenger processing node exists for the first data partition; determining that no challenger processing node has been designated within the node status log for the first data partition; re-stamping the processing node as a leader node for the first data partition; and taking a next step in a data processing flow for the first data partition.

### Embodiment 18

The method as in one of embodiments 16-17, wherein the method further comprises at the processing node assigned to the first data partition, detecting a triggering event that initiates a node status survey; upon said detecting the triggering event, surveying a node status log to determine whether a challenger processing node exists for the first data partition; determining that a challenger processing node has been designated within the node status log for the first data partition; removing the processing node from the node status log for the first data partition; and terminating the processing node.

### Embodiment 19

The method as in one of embodiments 16-18, wherein the triggering event is completion of writing a result of the data processing to data to storage.

### Embodiment 20

The method as in one of embodiments 16-19, wherein the triggering event is completion of a data aggregation process from the first partition in preparation for batch processing.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. A computing system comprising:
a processor; and
computer storage memory having computer-executable instructions stored thereon which, when executed by the processor, configure the computing system to:
at a processing node assigned to a first data partition, detect a triggering event that initiates a node status survey;
upon detecting the triggering event, conduct a node status survey to determine whether a challenger processing node exists for the first data partition;
determine that the challenger processing node exists for the first data partition; and
in response to determining that the challenger processing node exists, terminate the processing node.

2. The system of claim 1, wherein the triggering event is the passage of a designated amount of time since a previous status survey was performed by the processing node.

3. The system of claim 1, wherein the method further comprises removing the association between the processing node and the first data partition.

4. The system of claim 1, wherein the triggering event is completion of a data aggregation process from the first partition in preparation for batch processing.

5. The system of claim 1, wherein the triggering event is completion of a data processing step prior to writing a result of the data processing to storage.

6. The system of claim 1, wherein the triggering event is completion of writing a result of the data processing to data to storage.

7. The system of claim 1, wherein the processing node is a virtual machine.

8. A method of managing atomic processing of a data partition, the method comprising:
at a processing node assigned to a first data partition, detecting a triggering event that initiates a node status survey;
upon said detecting the triggering event, surveying a node status log to determine whether a challenger processing node exists for the first data partition;
determining that no challenger processing node has been designated within the node status log for the first data partition;
re-stamping the processing node as a leader node for the first data partition; and
taking a next step in a data processing flow for the first data partition.

9. The method of claim 8, wherein the triggering event is the passage of a designated amount of time since a status survey was last performed by the processing node.

10. The method of claim 9, wherein the designated amount of time is between ten seconds and five minutes.

11. The method of claim 8, wherein the triggering event is completion of a data aggregation process from the first partition in preparation for batch processing.

12. The method of claim 8, wherein the triggering event is completion of a data processing step prior to writing a result of the data processing to storage.

13. The method of claim 8, wherein the triggering event is completion of writing a result of the data processing to data to storage.

14. The method of claim 8, wherein the processing node is within a parallel processing computer environment.

15. The method of claim 8, wherein the method further comprises:
determining that a leader node is listed within the node status log for the designated data partition;
waiting a threshold period of time and rechecking the node status log;
determining that the leader node is no longer listed within the node status log for the designated data partition; and
beginning to process data within the designated data partition.

16. A method managing atomic processing of a data partition comprising:
at a processing node assigned to a first data partition, surveying a node status log to determine that a leader node is listed within the node status log for the first data partition;
waiting a threshold period of time and then resurveying the node status log;
determining that the leader node is no longer listed within the node status log for the first data partition; and
beginning to process data within the designated data partition.

17. The method of claim 16, further comprising:
at the processing node assigned to the first data partition, detecting a triggering event that initiates a node status survey;
upon said detecting the triggering event, surveying a node status log to determine whether a challenger processing node exists for the first data partition;
determining that no challenger processing node has been designated within the node status log for the first data partition;
re-stamping the processing node as a leader node for the first data partition; and
taking a next step in a data processing flow for the first data partition.

18. The method of claim 16, wherein the method further comprises
at the processing node assigned to the first data partition, detecting a triggering event that initiates a node status survey;
upon said detecting the triggering event, surveying a node status log to determine whether a challenger processing node exists for the first data partition;
determining that a challenger processing node has been designated within the node status log for the first data partition;
removing the processing node from the node status log for the first data partition; and
terminating the processing node.

19. The method of claim 16, wherein the triggering event is completion of writing a result of the data processing to data to storage.

20. The method of claim 16, wherein the triggering event is completion of a data aggregation process from the first partition in preparation for batch processing.
